(19) United States
(12) Patent Application Publication
(10) Pub. No.: US 2011/0206274 A1
(43) Pub. Date: Aug. 25, 2011

(54) POSITION AND ORIENTATION ESTIMATION APPARATUS AND POSITION AND ORIENTATION ESTIMATION METHOD

(75) Inventors: Keisuke Tateno, Kawasaki-shi (JP); Daisuke Kotake, Yokohama-shi (JP); Kazuhiko Kobayashi, Yokohama-shi (JP); Shinji Uchiyama, Yokohama-shi (JP)

(73) Assignee: CANON KABUSHIKI KAISHA, Tokyo (JP)

(21) Appl. No.: 13/030,487

(22) Filed: Feb. 18, 2011

(30) Foreign Application Priority Data
Feb. 25, 2010 (JP) 2010-040594

(51) Int. Cl. G06K 9/00

(52) U.S. Cl. 382/154

(57) ABSTRACT

A position and orientation estimation apparatus inputs an image capturing an object, inputs a distance image including three-dimensional coordinate data representing the object, extracts an image feature from the captured image, determines whether the image feature represents a shape of the object based on three-dimensional coordinate data at a position on the distance image corresponding to the image feature, correlates the image feature representing the shape of the object with a part of a three-dimensional model representing the shape of the object, and estimates the position and orientation of the object based on a correlation result.

### BACKGROUND OF THE INVENTION

1. Field of the Invention

The present invention relates to a technique capable of estimating the position and orientation of an object whose three-dimensional shape is known beforehand.

2. Description of the Related Art

Due to development of advanced techniques, various kinds of robots are available to perform a complicated task, such as a work for assembling industrial products, which has been conventionally done by human workers. To enable a robot having an end effector, such as a hand, to grip a product or a component, it is necessary to measure the position and orientation of each target product or component relative to the robot.

The position and orientation measurement technique is applicable not only to the above-described robotic assembling but also to other various purposes, such as position estimation for an autonomic movement of a robot or positioning between a physical space and a virtual object in an augmented reality system.

There is a conventional method for measuring the position and orientation of a target object based on a two-dimensional image captured with a camera. For example, the measurement according to a model fitting is usable to compare a feature extracted from a two-dimensional image with a three-dimensional shape model of the object. In this case, it is necessary to accurately correlate the feature extracted from the two-dimensional image with the feature of the three-dimensional shape model.

As discussed in Y. Liu, T. S. Huang, and O. D. Faugeras, “Determination of camera location from 2-D to 3-D line and point correspondences,” IEEE Transactions on Pattern Analysis and Machine Intelligence, vol. 12, no. 1, pp. 28-37, 1990 (hereinafter, referred to as non-patent literature 1), a conventional method includes fitting straight lines to edges extracted from an image and calculating the position and orientation of an object based on a correspondence between straight lines in an image and line segments of a three-dimensional model, without requiring any approximate position and orientation of the object.

According to the conventional method discussed in the non-patent literature 1, the position and orientation of an object can be calculated by solving linear equations derived from a correspondence between at least eight straight lines.

The above-described edge based method is desirably applicable in an environment in which there are many artificial objects having less texture and including straight lines. To perform the position and orientation estimation, obtaining a correspondence between straight lines included in an image and line segments of a three-dimensional model is necessary starting from a state where it is completely unknown.

In such cases, it is general to calculate a plurality of position and orientation data by randomly correlating line segments of the three-dimensional model to the straight lines included in the image and selecting position and orientation data that is optimum in matching.

Further, as discussed in T. Drummond and R. Cipolla, “Real-time visual tracking of complex structures,” IEEE Transactions on Pattern Analysis and Machine Intelligence, vol. 24, no. 7, pp. 932-946, 2002″ (hereinafter, referred to as non-patent literature 2), a conventional method uses edges as features extracted from a two-dimensional image in the measurement of the position and orientation of an object.

According to the conventional method discussed in the non-patent literature 2, an assembly of line segments (i.e., a wire frame model) is employed to express a three-dimensional shape model of an object and it is presumed that an approximate position and orientation of the object is already known. The position and orientation of the object can be measured by fitting a projection image of a three-dimensional line segment to the edges extracted from the image. In this case, the search object is limited to the edges positioned in the vicinity of the projection image of the line segment of the three-dimensional model. Thus, the number of edge candidates can be reduced.

Further, as discussed in H. Wuest, F. Vial, and D. Stricker, “Adaptive line tracking with multiple hypotheses for augmented reality,” Proc. The Fourth Int'l Symp. on Mixed and Augmented Reality (ISMAR05), pp. 62-69, 2005″ (hereinafter, referred to as non-patent literature 3), a conventional method uses peripheral luminance values to improve the accuracy in correlating a line segment of a three-dimensional model with edges.

More specifically, the conventional method discussed in the non-patent literature 3 includes storing a luminance distribution in the vicinity of an edge extracted from a gray image to the line segment of the three-dimensional model and correlating an edge having a closest luminance distribution with the stored luminance distribution.

Thus, edge correlation error can be reduced even if a plurality of edges (as corresponding candidates) is present in the vicinity of the projection position.

Further, time-sequentially acquiring a luminance distribution stored on a line segment of a three-dimensional model from a gray image and updating the acquired luminance distribution enable to identify each edge even when the luminance distribution in the vicinity of an edge included in an image has slightly changed.

Further, in the case of using feature points, enhancing the degree of identification is feasible because correlation processing is performed based on peripheral image information of the feature points, compared to a general method using edges.

Further, as discussed in T. Fujita, K. Sato, and S. Inokuchi, “Range image processing for bin-picking of curved object,” IAPR workshop on CV, 1988″ (hereinafter, referred to as non-patent literature 4), a conventional method includes preliminarily expressing a three-dimensional shape model of an object as an assembly of simple shapes (primitives), extracting a shape feature (e.g., local plane or angle) from a distance image, and measuring the position and orientation of the object based on matching between an extracted shape feature and the three-dimensional shape model.

The method using a distance image can be desirably employed when a target object has unique features in its three-dimensional shape. According to the non-patent literature 4, identification processing is performed based on information other than a gray image. The distance image is different from an image of a visible object. The distance image stores a distance value between the object and an imaging apparatus. Therefore, the distance image is robust against a change in luminance, which may be induced by a change of a light source or surface information of the object.

According to the non-patent literature 1, if a three-dimensional model includes numerous line segments, or when numerous straight lines are extracted from an image, the total number of correspondence combinations becomes a huge number. Therefore, a huge amount of calculations is required to search for the correspondence in calculating accurate position and orientation.

According to the non-patent literature 2, an edge positioned most closely to the projection image of the three-dimensional line segment is regarded as a corresponding edge. Therefore, in a case where the most-closely detected edge is not an inherently corresponding edge, the position and orientation calculation may fail or the estimation accuracy may decrease.

In particular, when the approximate position and orientation is inaccurate, or when a target two-dimensional image is complicated and includes many edges as corresponding candidates, error correspondence may occur in the correlation between a line segment of a three-dimensional shape model and an edge. Further, the estimation of the position and orientation may fail.

According to the non-patent literature 3, if there are many repetition patterns, unobvious correspondence may remain. In this respect, the method discussed in the non-patent literature 3 is similar to the method using edges.

Further, in a case where the target object includes a lesser amount of texture information, the correlating processing using the luminance of a gray image is disadvantageous in that identification of an image feature may deteriorate and error correspondence in the feature correlating processing may occur.

Further, even in a case where an abrupt change of the light source occurs as illustrated in FIG. 2, the image feature identification based on the luminance does not work effectively and the accuracy in the feature correlating processing decreases.

The above-described problems may occur when the feature identification is performed based on the luminance of a gray image. The luminance of a gray image changes in various ways depending on surface information of an object, operational state of a light source, and viewpoint position from which the object is observed. Therefore, these factors significantly influence the method performing the correlating processing based on the luminance.

According to the non-patent literature 4, the distance image is handled as a target to be fitted to the three-dimensional model and is not used in correlating a feature extracted from a gray image.

### SUMMARY OF THE INVENTION

Exemplary embodiments of the present invention are directed to a technique capable of accurately estimating the position and orientation of a target object by utilizing shape information of the target object based on distance data to identify image information extracted from a gray image.

According to an aspect of the present invention, a position and orientation estimation apparatus includes a storage unit configured to store a three-dimensional model representing a shape of an object, an extraction unit configured to extract an image feature from an image including the captured object, an input unit configured to input a distance image that includes measured information relating to the object, a correlating unit configured to correlate the image feature corresponding to the distance image that coincides with the three-dimensional model in shape, with the three-dimensional model, and an estimation unit configured to estimate the position and orientation of the object based on a correlating result obtained by the correlating unit.

According to another aspect of the present invention, a position and orientation estimation method includes storing a three-dimensional model representing a shape of an object, extracting an image feature from an image including the captured object, inputting a distance image that includes measured information relating to the object, correlating the image feature corresponding to a portion of the distance image that coincides with the three-dimensional model in shape, with the three-dimensional model, and estimating the position and orientation of the object based on an obtained correlating result.

According to an aspect of the present invention, a non-transitory computer-readable storage medium stores a program that causes a computer to perform position and orientation estimation processing. The program includes computer-executable instructions for storing a three-dimensional model representing a shape of an object, computer-executable instructions for extracting an image feature from an image including the captured object, computer-executable instructions for inputting a distance image that includes measured information relating to the object, computer-executable instructions for correlating the image feature corresponding to a portion of the distance image that coincides with the three-dimensional model in shape, with the three-dimensional model, and computer-executable instructions for estimating the position and orientation of the object based on an obtained correlation result.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a position and orientation estimation apparatus according to a first exemplary embodiment of the present invention.

FIG. 2 illustrates a luminance distribution change in the vicinity of an edge, which may be induced by a change in mutual position and orientation between a target object and a light source environment.

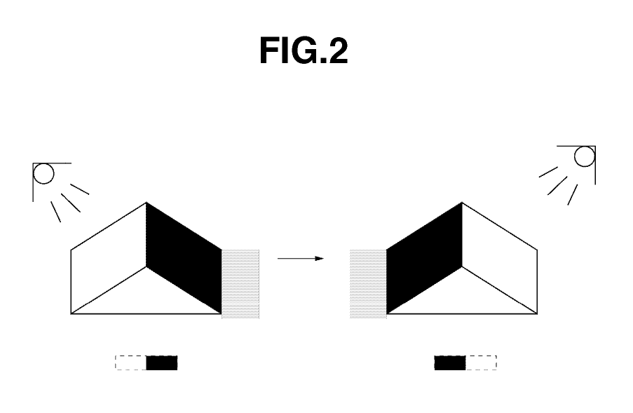

FIGS. 3A, 3B, 3C, 3D, and 3E illustrate an example method for defining three-dimensional model data according to the first exemplary embodiment of the present invention.

FIG. 4 is a flowchart illustrating an example procedure of position and orientation estimation processing according to the first exemplary embodiment of the present invention.

FIG. 5 is a flowchart illustrating a detailed procedure of processing for detecting an edge from a gray image according to the first exemplary embodiment of the present invention.

FIGS. 6A and 6B illustrate an example detection of edges from a gray image according to the first exemplary embodiment of the present invention.

FIGS. 7A, 7B, and 7C illustrate example processing for determining a three-dimensional attribute of a corresponding edge candidate according to the first exemplary embodiment of the present invention.

FIG. 8 illustrates a configuration of a position and orientation estimation apparatus according to a second exemplary embodiment of the present invention.

FIG. 9 is a flowchart illustrating an example procedure of position and orientation estimation processing according to the second exemplary embodiment of the present invention, which does not use any approximate position and orientation data.

FIG. 10 is a flowchart illustrating a detailed procedure of straight line detection processing according to the second exemplary embodiment of the present invention.

FIGS. 11A and 11B illustrate example processing for determining a three-dimensional attribute of a straight line included in a gray image according to the second exemplary embodiment of the present invention.

FIG. 12 illustrates a relationship between a straight line in an image and a straight line in a three-dimensional space.

### DESCRIPTION OF THE EMBODIMENTS

Various exemplary embodiments, features, and aspects of the invention will be described in detail below with reference to the drawings.

It should be noted that the relative arrangement of the components, the numerical expressions and numerical values set forth in these embodiments do not limit the scope of the present invention unless it is specifically stated otherwise.

(Estimation of Position and Orientation Based on Edge Correlating Using Distance Image)

In the first exemplary embodiment, it is presumed that an approximate position and orientation of an object is already known. A position and orientation estimation apparatus according to the present exemplary embodiment is operable to estimate the position and orientation of an object based on a correspondence between a three-dimensional model and edges extracted from an actually captured image.

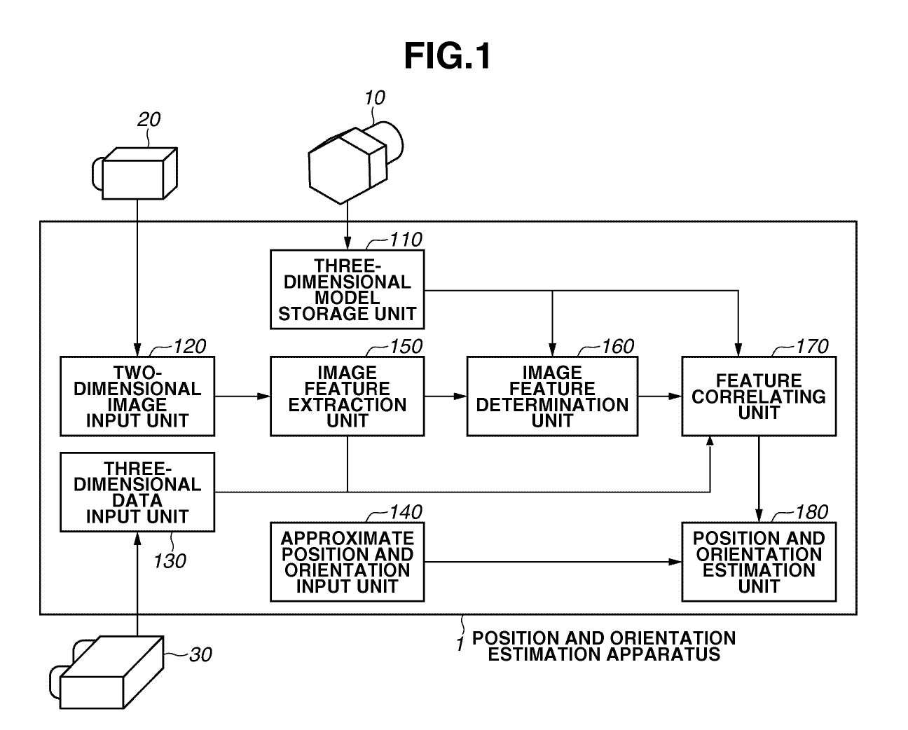

FIG. 1 illustrates an example of the configuration of a position and orientation estimation apparatus 1 that performs position and orientation estimation based on three-dimensional model data 10 that represents the shape of an observation target object.

The position and orientation estimation apparatus 1 includes a three-dimensional model storage unit 110, a two-dimensional image input unit 120, a three-dimensional data input unit 130, an approximate position and orientation input unit 140, an image feature extraction unit 150, an image feature determination unit 160, a feature correlating unit 170, and a position and orientation estimation unit 180.

The three-dimensional model storage unit 110 stores the three-dimensional model data 10. The three-dimensional model storage unit 110 is connected to the image feature determination unit 160 and the feature correlating unit 170.

A two-dimensional image capturing apparatus 20 is connected to the two-dimensional image input unit 120. A three-dimensional coordinate measurement apparatus 30 is connected to the three-dimensional data input unit 130.

The position and orientation estimation apparatus 1 measures the position and orientation of an observation target object included in a captured two-dimensional image based on the three-dimensional model data 10 that represents the shape of the observation target object stored in the three-dimensional model storage unit 110.

In the present exemplary embodiment, the position and orientation estimation apparatus 1 can perform position and orientation measurement processing only when the shape of an actually captured observation target object substantially coincides with the three-dimensional model data 10 stored in the three-dimensional model storage unit 110.

The constitute components of the position and orientation estimation apparatus 1 are described below in more detail.

The two-dimensional image capturing apparatus 20 is a camera that can capture an ordinary two-dimensional image. A captured two-dimensional image may be a gray image or can be a color image.

In the present exemplary embodiment, the two-dimensional image capturing apparatus 20 can output a gray image and is configured to preliminarily calibrate functional parameters of the camera (e.g., focal length, principal point position, and lens distortion parameter), for example, using the method discussed in R. Y. Tsai, “A versatile camera calibration technique for high-accuracy 3D machine vision metrology using off-the-shelf TV cameras and lenses,” IEEE Journal of Robotics and Automation, vol. RA-3, no. 4, 1987″ (hereinafter, referred to as non-patent literature 5).

The two-dimensional image input unit 120 can input an image captured by the two-dimensional image capturing apparatus 20 to the position and orientation estimation apparatus 1.

The three-dimensional coordinate measurement apparatus 30 can measure three-dimensional information of a point on the surface of a measurement target object. An example of the three-dimensional coordinate measurement apparatus 30 is a distance sensor capable of outputting a distance image. Each pixel constituting the distance image has depth information.

In the present exemplary embodiment, the distance sensor is an active type that is equipped with a camera capable of receiving reflection light of a laser beam from a target and configured to measure the distance of the target using a triangulation method.

However, the distance sensor is not limited to the above-described one. For example, the distance sensor can be a time-of-flight sensor capable of using flight time of light. The above-described active type distance sensors are effectively employable when a target object has a lesser amount of surface texture.

Further, the distance sensor can be a passive type that is capable of calculating the depth of each pixel using the triangulation based on images captured by a stereo camera. The passive type distance sensor is effectively employable when a target object has a sufficient amount of surface texture.

Further, any other sensor capable of measuring a distance image is usable in the present exemplary embodiment.

Three-dimensional coordinate data measured by the three-dimensional coordinate measurement apparatus 30 is input to the position and orientation estimation apparatus 1 via the three-dimensional data input unit 130.

In the present exemplary embodiment, it is presumed that the three-dimensional coordinate measurement apparatus 30 has an optical axis that coincides with an optical axis of the two-dimensional image capturing apparatus 20.

It is further presumed that the correspondence between each pixel of a two-dimensional image output from the two-dimensional image capturing apparatus 20 and each pixel of a distance image output from the three-dimensional coordinate measurement apparatus 30 is already known.

The three-dimensional data input unit 130 can input a distance image measured by the three-dimensional coordinate measurement apparatus 30 to the position and orientation estimation apparatus 1. It is presumed that the image capturing operation by the camera and the distance measurement by the distance sensor are simultaneously performed.

However, if the target object is a stationary object, the mutual position and orientation relationship between the position and orientation estimation apparatus 1, and the target object is not variable. In this case, it is unnecessary to simultaneously perform the image capturing operation by the camera and the distance measurement by the distance sensor.

The three-dimensional model storage unit 110 stores a three-dimensional shape model 10 of a target object to be measured in the position and orientation measurement. The three-dimensional shape model 10 can be used when the position and orientation estimation unit 180 calculates the position and orientation of the target object. In the present exemplary embodiment, it is presumed that each object can be expressed as a three-dimensional shape model constituted by line segments and planes.

The three-dimensional shape model can be defined with an assembly of points and an assembly of line segments each connecting two points. Further, the three-dimensional shape model stores three-dimensional attribute information of each line segment.

In the present exemplary embodiment, the three-dimensional attribute of each line segment is a three-dimensional attribute of an edge determined depending on a peripheral shape of the line segment. The three-dimensional attribute of each line segment can be classified into one of four types, i.e., convex shape (convex roof edge), concave shape (concave roof edge), discontinuously changing shape like a cliff (jump edge), and flat shape having an unchangeable shape (texture edge), according to the peripheral shape of the line segment.

The three-dimensional attribute information indicating the convex roof edge or the jump edge is variable depending on the viewing direction from which an object is observed. In this respect, the three-dimensional attribute information indicating the convex roof edge or the jump edge is dependent on an object observing orientation.

In the present exemplary embodiment, observation direction dependent information is excluded. The information to be stored as the three-dimensional attribute of an edge includes two patterns, i.e., edge constituting a shape changing portion (e.g., a roof edge or a jump edge) or an edge constituting a flat portion (e.g., a texture edge).

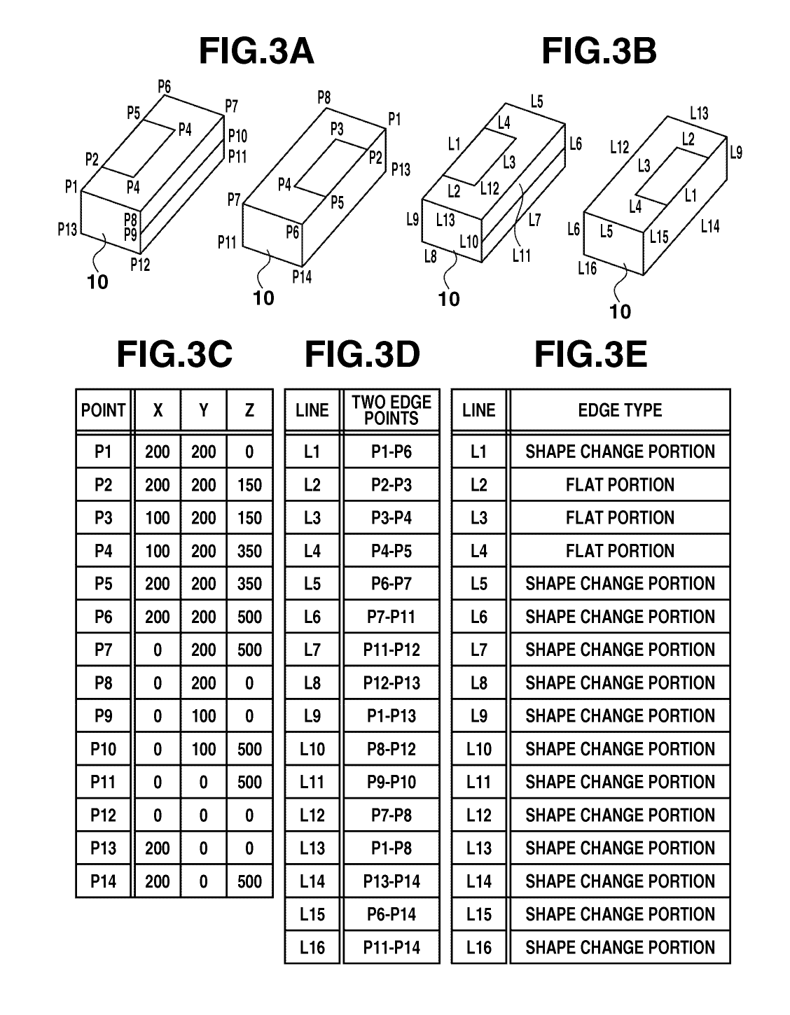

FIGS. 3A to 3E illustrate an example method for defining a three-dimensional model according to the present exemplary embodiment. The three-dimensional model can be defined as an assembly of points or an assembly of a plurality of line segments connecting these points.

FIG. 3A illustrates an example of the three-dimensional model including fourteen points (i.e., points P1 to P14). A standard coordinate system applied to the three-dimensional model has an origin that coincides with the point P12, an x-axis that extends from the point P12 to the point P13, a y-axis that extends from the point P12 to the point P8, a z-axis that extends from the point P12 to the point P11. The y-axis extends upward in the vertical direction (i.e., a direction opposed to the gravity-axis).

Further, FIG. 3B illustrates an example of the three-dimensional model including sixteen line segments L1 to L16. As illustrated in FIG. 3C, the points P1 to P14 can be defined by three-dimensional coordinate values.

Further, as illustrated in FIG. 3D, the line segments L1 to L16 can be defined by ID information of two points that constitute each line segment. Further, as illustrated in FIG. 3E, the line segments L1 to L16 store three-dimensional attribute information representing respective line segments.

The approximate position and orientation input unit 140 can input approximate values representing the position and orientation of an object relative to the position and orientation estimation apparatus 1. In the present exemplary embodiment, the position and orientation of an object relative to the position and orientation estimation apparatus 1 is information representing the position and orientation of the object defined in a camera coordinate system.

However, if the position and orientation of an object relative to the camera coordinate system is already known and is not variable, any portion of the position and orientation estimation apparatus 1 can be referred to as a reference point. In the present exemplary embodiment, the position and orientation estimation apparatus 1 continuously performs measurement in the time-axis direction and uses previously (early) obtained measurement values as approximate position and orientation data.

However, the method for inputting approximate values representing the position and orientation is not limited to the above-described method. For example, a time series filter can be used to estimate the moving speed or the angular speed of an object based on previously measured position and orientation. An estimated speed and/or an estimated acceleration can be used together with the previous position and orientation data to predict the present position and orientation.

Further, if any another sensor is available to measure the position and orientation of an object, output values of this sensor can be used as approximate values representing the position and orientation.

The sensor can be a magnetic sensor capable of measuring the position and orientation of an object. For example, the magnetic sensor can include a transmitter capable of generating a magnetic field and a receiver capable of detecting the magnetic field generated by the transmitter.

The sensor can be an optical sensor capable of measuring the position and orientation of an object by capturing an image of a marker positioned on the object with a camera whose position is fixed in a scene.

The sensor can be another type of sensor capable of measuring six-degree-of freedom position and orientation data. Further, in a case where the position or the orientation of an object is roughly known, the position or orientation value can be used as an approximate value.

The image feature extraction unit 150 can extract image features from a two-dimensional image input from the two-dimensional image input unit 120. In the present exemplary embodiment, the image feature extraction unit 150 can detect edges as image features.

The image feature determination unit 160 can determine whether an image feature extracted from a distance image represents the shape of an object. For example, an image feature of a borderline between a lightened portion and a shadow portion does not represent the shape of an object.

Utilizing a distance image enables to determine whether the detected image feature is an image feature of an edge of an object or an image feature of a shadow. In other words, the image feature determination unit 160 can reduce the number of candidate image features representing the shape.

The feature correlating unit 170 can correlate edges detected by the image feature extraction unit 150 with line segments that constitute a three-dimensional shape model stored in the three-dimensional model storage unit 110 based on three-dimensional point group information input by the three-dimensional data input unit 130. An example feature correlating method that can be employed by the feature correlating unit 170 is described below.

The position and orientation estimation unit 180 can measure the position and orientation of an object based on correlation information supplied from the feature correlating unit 170. Detailed processing to be performed by the position and orientation estimation unit 180 is described below.

A position and orientation estimation method according to the present exemplary embodiment is described below.

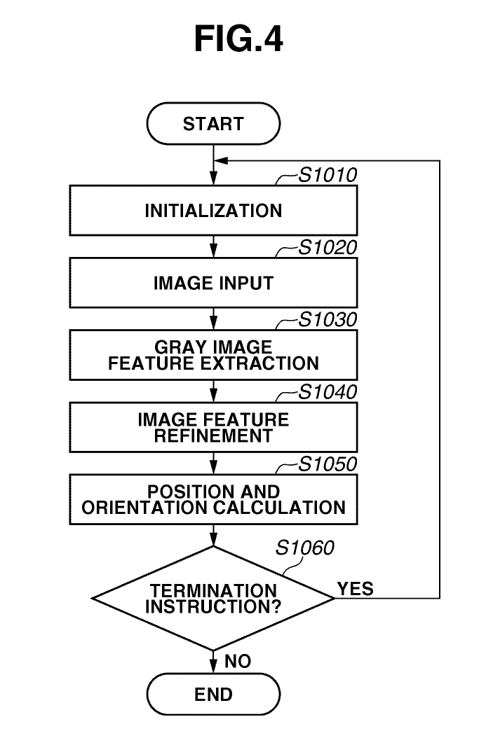

FIG. 4 is a flowchart illustrating a processing procedure of the position and orientation estimation method according to the present exemplary embodiment.

In step S1010, the position and orientation estimation apparatus 1 performs initialization. More specifically, the two-dimensional image input unit (i.e., approximate position and orientation input unit) 120 inputs approximate values representing the position and orientation of an object relative to the position and orientation estimation apparatus 1 (i.e., camera) to the position and orientation estimation apparatus 1 (i.e., three-dimensional measurement apparatus 1).

The position and orientation estimation method according to the present exemplary embodiment is a method for successively updating the approximate position and orientation of an imaging apparatus based on edge information of an observation target object included in a captured image.

Therefore, it is necessary to preliminarily set approximate position and orientation of the imaging apparatus as an initial position and an initial orientation before the position and orientation estimation apparatus 1 starts the position and orientation estimation. As described previously, in the present exemplary embodiment, the position and orientation estimation apparatus 1 uses position and orientation data having been previously measured.

In step S1020, the position and orientation estimation apparatus 1 acquires measurement data to calculate the position and orientation of the object according to the model fitting method.

More specifically, the position and orientation estimation apparatus 1 acquires a two-dimensional image of the target object and three-dimensional coordinate information. In the present exemplary embodiment, the two-dimensional image capturing apparatus 20 outputs a gray image as a two-dimensional image.

The three-dimensional coordinate measurement apparatus 30 outputs a distance image as the three-dimensional coordinate information. Compared to each pixel of the two-dimensional image which stores a gray value or a color value, each pixel of the distance image stores a value representing the depth from the viewpoint position.

As described above, the optical axis of the two-dimensional image capturing apparatus 20 coincides with the optical axis of the three-dimensional coordinate measurement apparatus 30. Therefore, the correspondence between each pixel of a gray image and each pixel of a distance image is already known.

In step S1030, the position and orientation estimation apparatus 1 performs image feature extraction processing on the two-dimensional image input in step S1020. In the present exemplary embodiment, the position and orientation estimation apparatus 1 detects edges of the target object as image features.

Each edge is a point having an extreme value in the gradient of gray level. In the present exemplary embodiment, the position and orientation estimation apparatus 1 performs edge detection processing according to the method discussed in the non-patent literature 3.

The processing to be performed in step S1030 is described below in more detail.

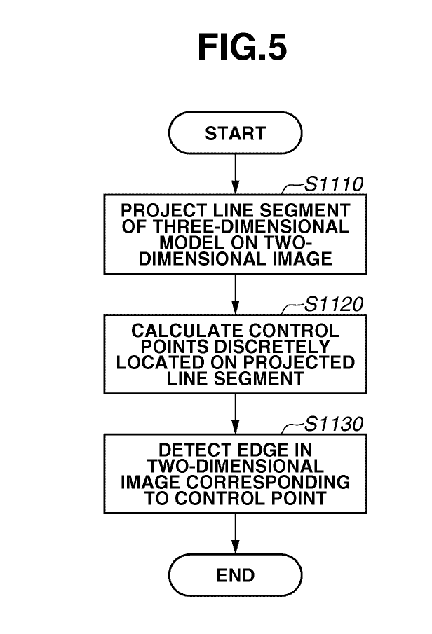

FIG. 5 is a flowchart illustrating a detailed procedure of processing for detecting edge features from a gray image according to the present exemplary embodiment.

In step S1110, the position and orientation estimation apparatus 1 calculates a projection image of each line segment that constitutes a three-dimensional shape model, in a case where the line segment is projected on an image, using the approximate position and orientation of the measurement target object input in step S1010 and corrected internal parameters of the two-dimensional image capturing apparatus 20. The projection image of each line segment becomes a line segment when projected on the image.

In step S1120, the position and orientation estimation apparatus 1 sets control points on the projected line segment calculated in step S1110. In the present exemplary embodiment, the control points are located at equal intervals on the projected line segment.

Each control point stores two-dimensional coordinate data of the control point and a two-dimensional direction of the line segment, which are obtained as a projection result, and three-dimensional coordinate data of a control point on a three-dimensional model and a three-dimensional direction of the line segment.

Further, the control point stores three-dimensional attribute information held by the line segment of the three-dimensional model (i.e., a division source of the control point). In the present exemplary embodiment, DFi (i=1, 2, . . . , N) represents each control point on the projected line segment when N represents the total number of the control points.

When the total number N of the control points is large, longer processing time is required. Therefore, it is useful to flexibly change the intervals of control points so that the total number of the control points becomes constant.

In step S1130, the position and orientation estimation apparatus 1 detects an edge in the two-dimensional image that corresponds to the control point DFi (i=1, 2, . . . , N) of the projected line segment obtained in step S1120.

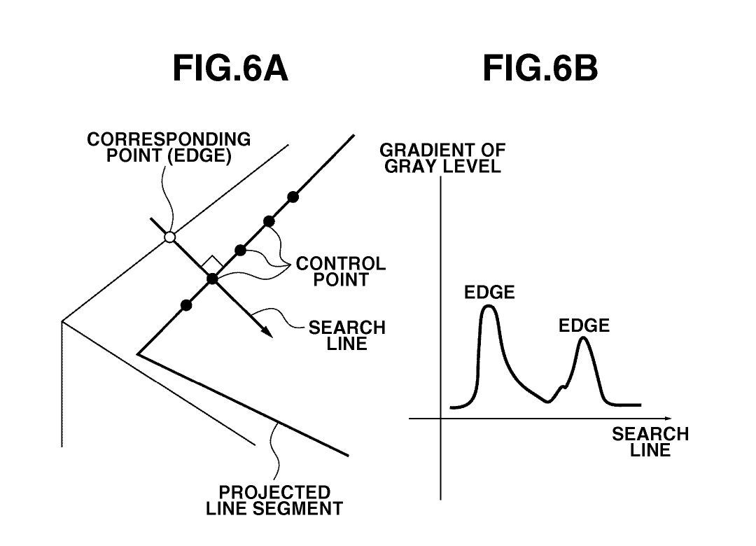

FIGS. 6A and 6B illustrate example edge detection according to the present exemplary embodiment. The edge detection performed by the position and orientation estimation apparatus 1 includes calculating an extreme value based on the gradient of gray level on a captured image along a search line of the control point DFi (i.e., a normal extending in a two-dimensional direction from the control point), as illustrated in FIG. 6A.

The position where the edge is present is a position where the gradient of gray level takes an extreme value on the search line. If only one edge is detected on the search line, the position and orientation estimation apparatus 1 regards the detected edge as a corresponding point and stores its two-dimensional coordinate data.

Further, as illustrated in FIG. 6B, if two or more edges are detected on the search line, the position and orientation estimation apparatus 1 stores the detected edges as a plurality of corresponding edge candidates together with their two-dimensional coordinate data, similar to the method discussed in the non-patent literature 3.

The position and orientation estimation apparatus 1 repeats the above-described processing for all control points DFi and, if the processing is completed for all control points DFi, the position and orientation estimation apparatus 1 terminates the processing in step S1030. Then, the processing proceeds to step S1040.

In step S1040, the position and orientation estimation apparatus 1 determines a three-dimensional attribute of the corresponding edge candidate that corresponds to the control point DFi (i=1, 2, . . . , N) of the projected line segment obtained in step S1030, and refines the corresponding edge candidates.

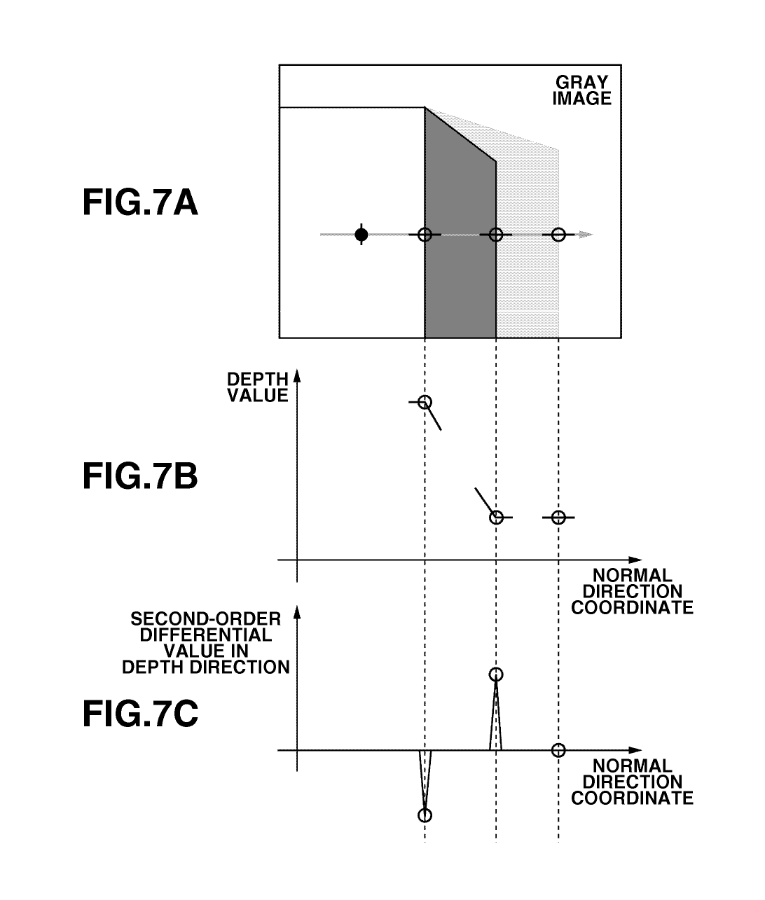

FIGS. 7A and 7B illustrate example processing for determining a three-dimensional attribute of each corresponding edge candidate. As illustrated in FIGS. 7A and 7B, the processing includes acquiring a distance value of a peripheral area of a corresponding edge candidate of the control point. In the present exemplary embodiment, the processing includes acquiring distance values of ten pixels, as a corresponding edge candidate peripheral area, along the normal direction of the control point with the corresponding edge candidate positioned at the center.

Next, as illustrated in FIG. 7C, the processing includes calculating a second-order differential value on the distance value of the corresponding edge candidate peripheral area. If there is any calculated second-order differential value whose absolute value is equal to or greater than a predetermined level, the processing can determine that the corresponding edge candidate is an edge of a portion where the distance value changes discontinuously, i.e., a shape change portion.

On the other hand, if there is not any calculated second-order differential value whose absolute value is equal to or greater than the predetermined level, the processing can determine that the corresponding edge candidate is an edge of a flat shape portion.

Further, if an unmeasured area where no distance value can be acquired is included in the corresponding edge candidate peripheral area, the processing can determine that the corresponding edge candidate is an edge of a shape change portion. The position and orientation estimation apparatus 1 repetitively performs the above-described processing on all corresponding edge candidates held by the control point to determine the three-dimensional attribute of each corresponding edge candidate.

Next, the position and orientation estimation apparatus 1 refines the corresponding edge candidate of the control point Dfi based on a comparison between the three-dimensional attribute of the corresponding edge candidate determined through the above-described processing and the three-dimensional attribute of the control point held by the control point.

If the compared three-dimensional attributes are different from each other, the position and orientation estimation apparatus 1 excludes the determined corresponding edge candidate as it is not a true candidate. The above-described processing enables to prevent any uncorresponding edge from being stored as a corresponding edge candidate.

As a result, only the corresponding edge candidate that is similar to the control point in attribute can be stored as a likely corresponding candidate. Further, if a plurality of corresponding edge candidates still remains at this stage of the refinement processing, the position and orientation estimation apparatus 1 selects the corresponding edge candidate positioned most closely to the control point as a correspondence edge.

The position and orientation estimation apparatus 1 repeats the above-described processing for all control points DFi. If the corresponding edge candidate refinement processing for all control points DFi is completed, the position and orientation estimation apparatus 1 terminates the processing in step S1040. Then, the processing proceeds to step S1050.

In step S1050, the position and orientation estimation apparatus 1 calculates the position and orientation of the target object using a nonlinear optimization method, according to which the approximate position and orientation of the target object is corrected based on repetitive calculations.

In the present exemplary embodiment, Lc represents the total number of the control points having corresponding edge candidates obtained in step S1040 among the control points DFi of the three-dimensional line segment. Further, the horizontal direction of an image is set to be equal to the x-axis and the vertical direction of the image is set to be equal to the y-axis.

Further, (u0, v0) represents the image coordinates of a projected control point. The gradient corresponding to the direction of the control point on the image is equal to the gradient θ relative to the x-axis.

The position and orientation estimation apparatus 1 calculates the gradient θ as a gradient of a straight line connecting edge points (start point and end point) of the projected three-dimensional line segment, i.e., connecting two-dimensional coordinate points on the captured image.

Further, (sin θ, −cos θ) represents a normal vector of the straight line of the control point on an image. Further, (u′, v′) represents image coordinates of a corresponding point of the control point.

In the present exemplary embodiment, a straight line passing through a point (u, v) and having the gradient θ can be expressed using the following equation.

x sin θ−y cos θ=u sin θ−v cos θ (1)

The image coordinate data on a captured image of a control point is variable depending on the position and orientation of an imaging apparatus. Further, the position and orientation of the imaging apparatus has six-degree-of-freedom.

In the present exemplary embodiment, “s” is a parameter representing the position and orientation of the imaging apparatus. The parameter “s” is a six dimensional vector, which includes three elements representing the position of the imaging apparatus and three elements representing the orientation of the imaging apparatus.

The elements representing the orientation can be, for example, expressed using Euler angles or three-dimensional vectors having the direction representing the rotational axis and the size representing the rotational angle.

The following formula (2) is an approximation of the image coordinates (u, v) of the control point, which can be obtained by applying a first-order Taylor expansion in the vicinity of the image coordinates (u0, v0).

$$u \approx {u}_{0} + {\sum }_{i = 1}^{6} \frac{\partial u}{\partial {s}_{i}} Δ {s}_{i} , v \approx {v}_{0} + {\sum }_{i = 1}^{6} \frac{\partial v}{\partial {s}_{i}} Δ {s}_{i} \qquad ( 2 )$$

The method for deriving partial differentiations δu/δsi and δv/δsi of the coordinate values u and v is widely known as discussed, for example, in K. Satoh, S. Uchiyama, H. Yamamoto, and H. Tamura, “Robust vision-based registration utilizing bird's-eye view with user's view,” Proc. The 2nd IEEE/ACM International Symposium on Mixed and Augmented Reality (ISMAR03), pp. 46-55, 2003″ (hereinafter, referred to as non-patent literature 6).

The following formula (3) can be obtained by inputting the approximated image coordinates (see the formula (2)) into the above-described equation (1).

$$x sin θ - y cos θ = ( {u}_{0} + {\sum }_{i = 1}^{6} \frac{\partial u}{\partial {s}_{i}} Δ {s}_{i} ) sin θ - ( {v}_{0} + {\sum }_{i = 1}^{6} \frac{\partial v}{\partial {s}_{i}} Δ {s}_{i} ) cos θ \qquad ( 3 )$$

In the present exemplary embodiment, the position and orientation estimation apparatus 1 calculates a correction value Δs of the position and orientation “s” of the imaging apparatus in such a way that the straight line represented by the formula (3) passes through the image coordinates (u′, v′) of the corresponding point of the control point.

r₀=u₀ sin θ−v₀ cos θ

d=u′ sin θ−v′ cos θ

When r₀ and d are constant values, the following formula can be derived.

$$sin θ {\sum }_{i = 1}^{6} \frac{\partial u}{\partial {s}_{i}} Δ {s}_{i} - cos θ {\sum }_{i = 1}^{6} \frac{\partial v}{\partial {s}_{i}} Δ {s}_{i} = d - {r}_{0} \qquad ( 4 )$$

The equation (4) can be obtained for a total of Lc control points. Therefore, the following linear simultaneous equations (5) can be obtained with respect to the correction value Δs.

$$[ \begin{matrix}sin {θ}_{1} \frac{\partial {u}_{1}}{\partial {s}_{1}} - cos {θ}_{1} \frac{\partial {v}_{1}}{\partial {s}_{1}} & sin {θ}_{1} \frac{\partial {u}_{1}}{\partial {s}_{2}} - cos {θ}_{1} \frac{\partial {u}_{1}}{\partial {s}_{2}} & … & sin {θ}_{1} \frac{\partial {u}_{1}}{\partial {s}_{6}} - cos {θ}_{1} \frac{\partial {v}_{1}}{\partial {s}_{6}} \\ sin {θ}_{1} \frac{\partial {u}_{2}}{\partial {s}_{1}} - cos {θ}_{1} \frac{\partial {v}_{2}}{\partial {s}_{1}} & sin {θ}_{1} \frac{\partial {u}_{2}}{\partial {s}_{2}} - cos {θ}_{1} \frac{\partial {v}_{2}}{\partial {s}_{2}} & … & sin {θ}_{2} \frac{\partial {u}_{2}}{\partial {s}_{6}} - cos {θ}_{1} \frac{\partial {u}_{2}}{\partial {u}_{6}} \\ ⋮ & ⋮ & ⋱ & ⋮ \\ sin {θ}_{{L}_{c}} \frac{\partial {u}_{{L}_{c}}}{\partial {s}_{1}} - cos {θ}_{1} \frac{\partial {v}_{{L}_{c}}}{\partial {s}_{1}} & sin {θ}_{{L}_{c}} \frac{\partial {u}_{{L}_{c}}}{\partial {s}_{2}} - cos {θ}_{{L}_{c}} \frac{\partial {v}_{{L}_{c}}}{\partial {s}_{2}} & … & sin {θ}_{{L}_{c}} \frac{\partial {u}_{{L}_{c}}}{\partial {s}_{6}} - cos {θ}_{{L}_{c}} \frac{\partial {v}_{{L}_{c}}}{\partial {s}_{6}}\end{matrix} ] [ \begin{matrix}Δ {s}_{1} \\ Δ {s}_{2} \\ Δ {s}_{3} \\ Δ {s}_{4} \\ Δ {s}_{5} \\ Δ {s}_{6}\end{matrix} ] = [ \begin{matrix}{d}_{1} - {r}_{1} \\ {d}_{2} - {r}_{2} \\ ⋮ \\ {d}_{{L}_{c}} - {r}_{{L}_{c}}\end{matrix} ] \qquad ( 5 )$$

The linear simultaneous equations (5) can be simply expressed using the following formula (6).

JΔₛ=E (6)

The correction value Δs is obtainable based on the equation (6) using a generalized inverse matrix (JT·J-)1JT of the matrix J according to the Gauss-Newton method. The position and orientation estimation apparatus 1 can update the position and orientation of the object based on the obtained correction value Δs.

Next, the position and orientation estimation apparatus 1 determines whether the repetitive calculation for obtaining the position and orientation of the object has converged.

If the correction value Δs is sufficiently small, when the summation of the error (r−d) is sufficiently small or fixed, the position and orientation estimation apparatus 1 determines that the repetitive calculation for obtaining the position and orientation of the object has converged.

If it is determined that the repetitive calculation for obtaining the position and orientation of the object has not yet converged, the position and orientation estimation apparatus 1 calculates again the gradient θ of the line segment, the above-described values r0 and d, and the partial differentiations of u and v based on the updated position and orientation of the object, and obtains again the correction value Δs based on the equation (6).

The nonlinear optimization method employed in the present exemplary embodiment is the Gauss-Newton method. However, the nonlinear optimization method is not limited to the above-described one. Any other nonlinear optimization method, such as Newton-Raphson method, Levenberg-Marquardt method, steepest descent method, or conjugate gradient method, can be employed. If the processing in step S1050 (i.e., the processing for calculating the position and orientation of the imaging apparatus) is completed, the processing proceeds to step S1060.

In step S1060, the position and orientation estimation apparatus 1 determines whether an instruction to terminate the position and orientation calculation is input. If it is determined that the termination instruction is input (YES in step S1060), the position and orientation estimation apparatus 1 terminates the processing of the flowchart illustrated in FIG. 4.

If it is determined that the termination instruction is not input (NO in step S1060), the processing returns to step S1010 in which the position and orientation estimation apparatus 1 newly acquires an image and performs again the position and orientation calculation processing on the acquired image.

As described above, the position and orientation estimation apparatus according to the present exemplary embodiment uses a distance image to identify a three-dimensional attribute of an edge extracted from an image and refines corresponding edge candidates. Therefore, the position and orientation estimation apparatus according to the present exemplary embodiment can prevent the detected edge from being erroneously correlated with a three-dimensional model.

Thus, even when the light source is variable or when many corresponding edge candidates are extracted from a gray image, the position and orientation estimation apparatus according to the present exemplary embodiment can realize high-accurate position and orientation estimation.

In the first exemplary embodiment, to correlate each pixel of a two-dimensional image captured by the two-dimensional image capturing apparatus 20 with each pixel of a distance image captured by the three-dimensional coordinate measurement apparatus, the two-dimensional image capturing apparatus 20 has the optical axis that coincide with that of the three-dimensional coordinate measurement apparatus 30.

However, the mutual relationship between the three-dimensional coordinate measurement apparatus 30 and the two-dimensional image capturing apparatus 20 is not limited to the above-described one. For example, the three-dimensional coordinate measurement apparatus 30 and the two-dimensional image capturing apparatus 20 can be used even when their optical axes do not coincide with each other.

In this case, after a two-dimensional image and a distance image are measured in step S1020, the position and orientation estimation apparatus 1 calculates a distance value corresponding to each pixel of the two-dimensional image.

More specifically, the position and orientation estimation apparatus 1 converts three-dimensional coordinate data of a point group measured by the three-dimensional coordinate measurement apparatus 30 in the camera coordinate system into data in the camera coordinate system of the two-dimensional image capturing apparatus, by utilizing the mutual position and orientation relationship between the three-dimensional coordinate measurement apparatus 30 and the two-dimensional image capturing apparatus 20.

Then, the position and orientation estimation apparatus 1 obtains the distance value corresponding to each pixel of the two-dimensional image by projecting three-dimensional coordinate data on the two-dimensional image to correlate the three-dimensional coordinate data with each pixel of the two-dimensional image.

In this case, if there are two or more three-dimensional points mapped to a pixel of the two-dimensional image, the point to be correlated by the position and orientation estimation apparatus 1 is a three-dimensional point closest to the viewpoint position.

Further, in a case where three-dimensional coordinate data is not projected to a pixel of the two-dimensional image and the correspondence cannot be obtained, the position and orientation estimation apparatus 1 sets a disabled value as the distance value and handles this pixel as an unmeasured pixel.

The above-described processing can be realized when the two-dimensional image capturing apparatus 20 and the three-dimensional coordinate measurement apparatus 30 are mutually fixed in positional relationship and the relative relationship between the two-dimensional image capturing apparatus 20 and the three-dimensional coordinate measurement apparatus 30 can be preliminarily calibrated.

Performing the above-described processing enables to calculate the distance value corresponding to each pixel of the two-dimensional image using the two-dimensional image capturing apparatus 20 and the three-dimensional coordinate measurement apparatus 30 whose optical axes do not coincide with each other.

In the first exemplary embodiment, to determine the three-dimensional attribute of each corresponding edge candidate, the position and orientation estimation apparatus 1 refers to a distance value of the corresponding edge candidate peripheral area, then determines a discontinuous area based on a calculated second-order differential value of the distance value, and identifies the three-dimensional attribute of the corresponding edge candidate.

However, the three-dimensional attribute determination method is not limited to the above-described one. For example, an employable method includes performing edge detection processing on a distance image and determining a three-dimensional attribute based on a detected result.

More specifically, in a case where an edge extracted from the distance image is present in the vicinity of the corresponding edge candidate, it is determined that the edge represents a shape change portion. If no edge is extracted from the distance image, it is determined that the edge represents a flat portion.

The method for determining a three-dimensional attribute of a corresponding edge candidate is not limited to the above-described one. Any other method is employable if the three-dimensional attribute can be determined based on a three-dimensional shape of the corresponding edge candidate.

The three-dimensional model used in the first exemplary embodiment is a three-dimensional line segment model. However, the three-dimensional model is not limited to the three-dimensional line segment model. The type of the three-dimensional model is not limited to a specific one. The three-dimensional model can be any other type if a three-dimensional line segment and a three-dimensional attribute of the line segment can be derived from the three-dimensional model.

For example, a mesh model including vertex information and plane (i.e., two-dimensional connection of vertices) information is usable. The expression using parametric curved surfaces, such as NURBS curved surfaces, is also employable. In these cases, directly referring to three-dimensional line segment information from the shape information is difficult.

Therefore, it is necessary to perform runtime calculation of the three-dimensional line segment information. Further, it is necessary to calculate a three-dimensional attribute of a three-dimensional line segment instead of performing the three-dimensional line segment projection processing.

More specifically, the position and orientation estimation apparatus 1 draws a three-dimensional model using the computer graphics (CG) technique based on an approximate position and orientation of a measurement target object and performs edge detection on a drawing result. The position and orientation estimation apparatus obtains control points so that detected edges are aligned at equal intervals.

Then, the position and orientation estimation apparatus inversely projects the two-dimensional position of the control point to a three-dimensional mesh model to obtain three-dimensional coordinate data. However, in this case, the position and orientation estimation apparatus calculates a three-dimensional attribute of an edge using a depth image (storing a distance value from a viewpoint to the three-dimensional model), which can be secondarily obtained as a drawing result, instead of using the above-described distance image.

Through the above-described processing, the position and orientation estimation apparatus can calculate the control point together with the three-dimensional attribute of the edge and can estimate the position and orientation based on the obtained control point. The above-described method is advantageous in that preparation is easy because the three-dimensional model is not required to preliminarily store line segment type information.

In the first exemplary embodiment, the geometric type of each edge extracted from a gray image is limited to only two patterns; i.e., an edge of a shape change portion or an edge of a flat portion. However, the three-dimensional attribute of each edge is not limited to the above-described one.

For example, the edge of a shape change portion can be more finely classified into a convex roof edge detectable at a convex shape portion, a concave roof edge detectable at a concave shape portion, or a jump edge detectable at a discontinuous shape change portion.

If the total number of three-dimensional attributes to be determined is increased, it is feasible to strictly perform feature refinement. A target object may be differently observed, for example, as a convex roof edge or a jump edge, depending on the direction from which the object is observed.

Therefore, to accurately discriminate one from the other between the convex roof edge and the jump edge, it is necessary to store a plurality of pieces of three-dimensional attribute information so as to correspond to various orientations for observing the object.

Further, a target object may be differently observed, for example as a convex roof edge or a jump edge, depending on the distance from the viewpoint to the object to be observed. However, compared to a variation caused by the orientation, a change caused by the distance is not so large.

Therefore, if the observation distance is limited within a predetermined range, it is unnecessary to preliminarily store a plurality of pieces of three-dimensional attribute information so as to correspond to various distances from the viewpoint to the object.

Further, the three-dimensional attribute information of each edge is not limited to the above-described one. It is useful to classify the three-dimensional attribute information more precisely. For example, it is desired to discriminate a moderate roof edge from a steep roof edge. Further, it is useful to handle a shape change amount itself as a feature amount. Any type can be used as long as distance information is usable to identify an edge. The three-dimensional attribute information of each edge is not particularly restricted.

In the first exemplary embodiment, the information used in edge correlating processing is the shape information detectable from a distance image. However, the usable information is not limited to the above-described one. For example, in addition to the three-dimensional attribute information of each edge, it is useful to use a luminance distribution of a gray image as discussed in the non-patent literature 3. Utilizing the luminance distribution enables to identify an edge based on a luminance change of a target object that may occur at a texture edge.

(Position and Orientation Estimation not Requiring Approximate Position and Orientation)

The method described in the first exemplary embodiment includes refining a plurality of corresponding candidates using the distance image when the approximate position and orientation of an object is already known.

A method according to a second exemplary embodiment is employable when the correspondence between the approximate position and orientation of an object and a line segment is unknown. According to the second exemplary embodiment, the position and orientation of the object are calculated by correlating an edge extracted from a gray image with a line segment of a three-dimensional model using the distance image.

According to the above-described first exemplary embodiment, as the approximate position and orientation of the object is known beforehand, the number of corresponding edge candidates can be preliminarily reduced by searching for an edge existing in the vicinity of a line segment of the three-dimensional model.

However, in the second exemplary embodiment, as the approximate position and orientation of an object is unknown, it is necessary to start correlating processing from a state where the correspondence between an edge of a gray image and a line segment of the three-dimensional model is completely unknown.

Hence, the method according to the second exemplary embodiment includes calculating a three-dimensional attribute of an edge of a gray image using the distance image so as to reduce the total number of combinations of an edge of a gray image and a line segment of the three-dimensional model.

The method according to the second exemplary embodiment further includes randomly selecting some of the reduced combinations, and calculating a plurality of pieces of position and orientation data. The method further includes selecting the one having a highest matching degree to finally identify the three-dimensional position and orientation of an object.

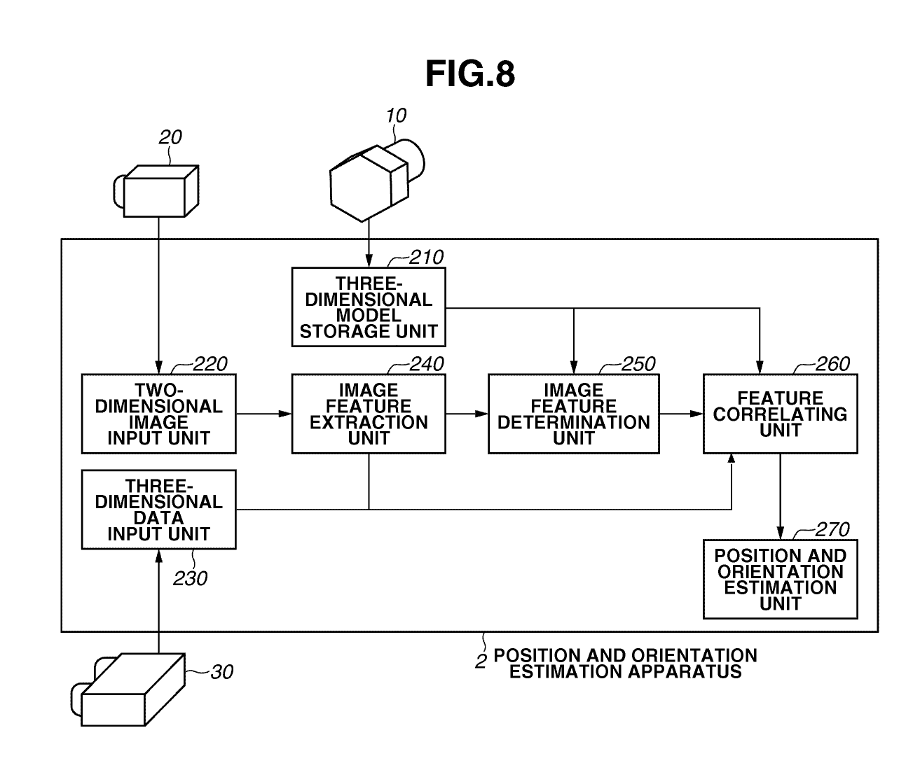

FIG. 8 illustrates a configuration of a position and orientation estimation apparatus 2 according to the present exemplary embodiment. The position and orientation estimation apparatus 2 includes a three-dimensional model storage unit 210, a two-dimensional image input unit 220, a three-dimensional data input unit 230, an image feature extraction unit 240, an image feature determination unit 250, a feature correlating unit 260, and a position and orientation estimation unit 270.

The two-dimensional image capturing apparatus 20 is connected to the two-dimensional image input unit 220. The three-dimensional coordinate measurement apparatus 30 is connected to the three-dimensional data input unit 230. The position and orientation estimation apparatus 2 measures the position and orientation of an observation target object in a captured two-dimensional image with reference to the three-dimensional model data 10 that represents the shape of the observation target object stored in the three-dimensional model storage unit 210.

The constituent components of the position and orientation estimation apparatus 2 are described below in more detail.

The three-dimensional model storage unit 210 stores the three-dimensional shape model 10 of a target object to be measured in the position and orientation measurement. A three-dimensional shape model expression method according to the present exemplary embodiment is substantially similar to the method described in the first exemplary embodiment.

Compared to the three-dimensional model storage unit 110, the three-dimensional model storage unit 210 stores information of a convex roof edge (an edge of a convex shape change portion), a concave roof edge (an edge of a concave shape change portion), and a texture edge (an edge of a flat portion), as three patterns of the three-dimensional attribute to be referred to in identification of an edge.

The image feature extraction unit 240 can extract an image feature from a two-dimensional image acquired by the two-dimensional image input unit 220.

The image feature determination unit 250 can determine whether an image feature extracted from a distance image represents the shape of an object.

The feature correlating unit 260 can calculate geometric information of the image feature extracted by the image feature extraction unit 240 using three-dimensional distance data input by the three-dimensional data input unit 230, and can correlate the calculated geometric information with a line segment in the three-dimensional model data 10.

The position and orientation estimation unit 270 can calculate the position and orientation of an object, using a direct solving method, based on the information correlated by the feature correlating unit 260.

The two-dimensional image input unit 220 and the three-dimensional data input unit 230 are similar to the two-dimensional image input unit 120 and the three-dimensional data input unit 130 described in the first exemplary embodiment. A position and orientation estimation method according to the present exemplary embodiment is described below.

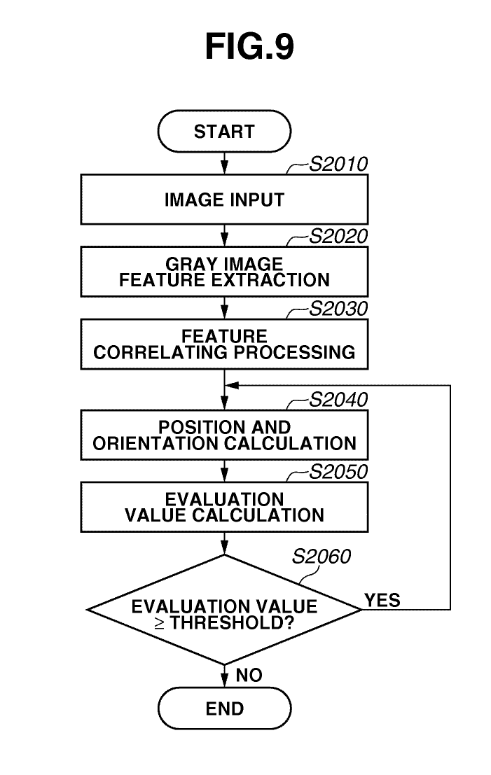

FIG. 9 is a flowchart illustrating an example procedure of position and orientation estimation processing according to the present exemplary embodiment.

In step S2010, the position and orientation estimation apparatus 2 acquires a gray image and a distance image. The processing to be performed in step S2010 is similar to the processing performed in step S1020 according to the first exemplary embodiment.

In step S2020, the position and orientation estimation apparatus 2 performs edge detection processing on the gray image acquired in step S2010 and detects a straight line using a broken line approximation.

The processing to be performed in step S2020 is described below in more detail.

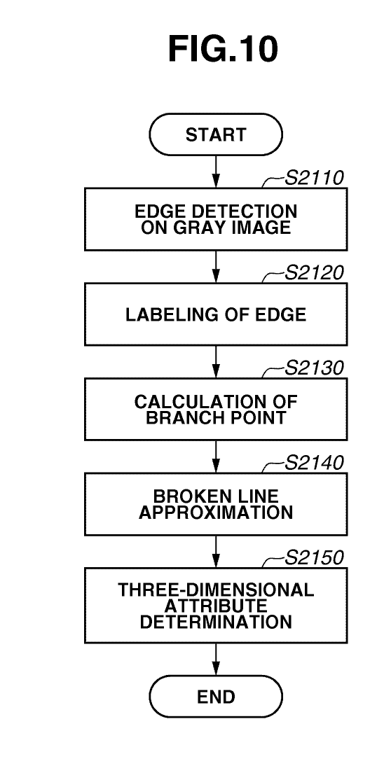

FIG. 10 is a flowchart illustrating a detailed procedure of straight line detection processing according to the present exemplary embodiment.

In step S2110, the position and orientation estimation apparatus 2 performs edge detection processing on the gray image. An example edge detection method may use, for example, an edge detection filter (e.g., a Sobel filter) or may use the Canny algorithm. Any other method is usable if it can detect an area where a pixel value of an image changes discontinuously. The selection of the method is not particularly restricted.

In the present exemplary embodiment, the position and orientation estimation apparatus 2 performs the edge detection processing using the Canny algorithm. Performing edge detection on a gray image using the Canny algorithm enables to obtain binary images that can be classified into edge areas and non-edge areas.

In step S2120, the position and orientation estimation apparatus 2 performs neighboring edge labeling processing on the binary image generated in step S2110. The labeling processing to be performed in step S2120, for example, includes checking whether an edge is present in eight neighboring pixels surrounding a concerned central pixel and, if the edge is detected, allocating the same label to these neighboring pixels.

In step S2130, the position and orientation estimation apparatus 2 searches for a point where a plurality of branches is connected, among the neighboring edges allocated the same label in step S2120. Then, the position and orientation estimation apparatus 2 cuts each branch at the detected branch point and allocates a different label to each branch having been cut.

In step S2140, the position and orientation estimation apparatus 2 performs broken line approximation processing on each branch that is allocated the label in step S2130.

The broken line approximation processing to be performed by the position and orientation estimation apparatus 2 includes, for example, connecting both edges of a branch with a line segment and providing a new division point at a point on the branch where the distance from the line segment is maximized and exceeds a threshold value.

The broken line approximation processing further includes connecting the newly provided division point to both edges of the branch with line segments and providing a division point where the distance from the line segment is maximized. The position and orientation estimation apparatus 2 recursively repeats the above-described processing until the branch can be sufficiently approximated by a broken line.

Subsequently, the position and orientation estimation apparatus 2 outputs coordinate values of both edges for each line segment constituting the broken line, as passing points of straight lines on the image.

In the present exemplary embodiment, the position and orientation estimation apparatus 2 performs labeling processing and broken line approximation to detect a straight line. However, the straight line detection processing is not limited to the above-described one. Any other method capable of detecting a straight line from an image is employable. For example, the Hough transformation can be used to detect a straight line.

In step S2150, the position and orientation estimation apparatus 2 determines a three-dimensional attribute of the straight line calculated in step S2140.

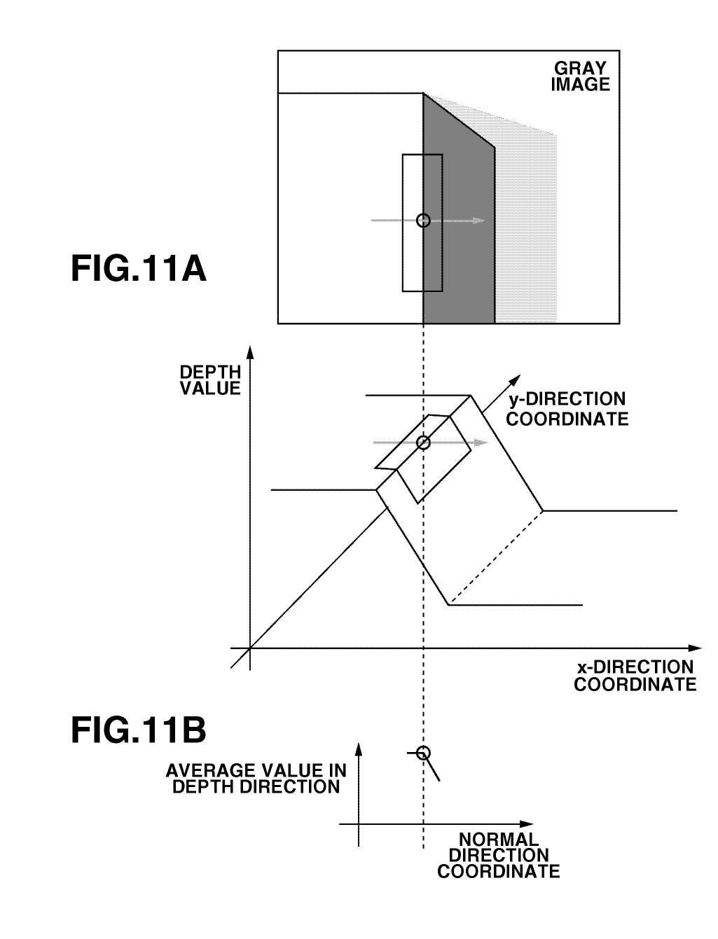

FIGS. 11A and 11B illustrate example processing for determining a three-dimensional attribute of a straight line included in a gray image.

As illustrated in FIG. 11A, the position and orientation estimation apparatus 2 acquires a distance value in a peripheral area of a concerned straight line. In the present exemplary embodiment, the position and orientation estimation apparatus 2 acquires an area composed of ten pixels aligned in the normal direction of the straight line and n/2 pixels aligned in the direction parallel to the straight line, as the peripheral area of the straight line, in which “n” represents the length of the concerned line segment.

Next, as illustrated in FIG. 11B, the position and orientation estimation apparatus 2 calculates an average value of the distance value in the direction parallel to the straight line. Through the above-described processing, the position and orientation estimation apparatus 2 calculates an average value vector of the distance value with respect to ten pixels in the normal direction of the straight line.

Then, the position and orientation estimation apparatus 2 obtains a three-dimensional attribute of the straight line based on the calculated distance value vector. If the distance value vector is a convex shape or a cliff shape (jump edge), the position and orientation estimation apparatus 2 determines that the edge is a convex roof edge.

If the distance value vector is a concave shape, the position and orientation estimation apparatus 2 determines that the edge is a concave roof edge. If the distance value vector is a flat shape, the position and orientation estimation apparatus 2 determines that the edge is a texture edge.

As described above, in the present exemplary embodiment, the jump edge is not discriminated from the convex roof edge and regarded as equivalent to the convex roof edge. If the position and orientation estimation apparatus 2 completes the above-described three-dimensional attribute determination processing for all of the straight lines, the processing proceeds to step S2030.

In step S2030, the position and orientation estimation apparatus 2 performs processing for correlating a straight line detection result obtained in step S2020 with a line segment of the three-dimensional model stored in the three-dimensional model storage unit 210.

First, the position and orientation estimation apparatus 2 compares a three-dimensional attribute of the line segment constituting the three-dimensional model with the three-dimensional attribute of the straight line detected in step S2020, and obtains a combination of the line segment constituting the three-dimensional model and the straight line detected in step S2020 that are similar in attribute.

The position and orientation estimation apparatus 2 performs the comparison of the three-dimensional attribute for all combinations of the line segment constituting the three-dimensional model and the straight line included in the image. If the above-described three-dimensional attribute type combination calculation is entirely completed, the position and orientation estimation apparatus 2 stores all obtained combinations. Then, the processing proceeds to step S2040.

In step S2040, the position and orientation estimation apparatus 2 calculates the position and orientation of the object based on eight pairs of correspondence information, which are randomly selected from the combinations of the line segment constituting the three-dimensional model and the straight line included in the image, which have been calculated in step S2030.

First, the position and orientation estimation apparatus 2 randomly selects eight pairs of combinations from all combinations of the line segment constituting the three-dimensional model and the straight line included in the image, which have been calculated in step S2030, and stores the selected eight pairs of combinations as the correspondence between the line segment constituting the three-dimensional model and the straight line included in the image. The position and orientation estimation apparatus 2 calculates the position and orientation of the object based on the stored correspondence.

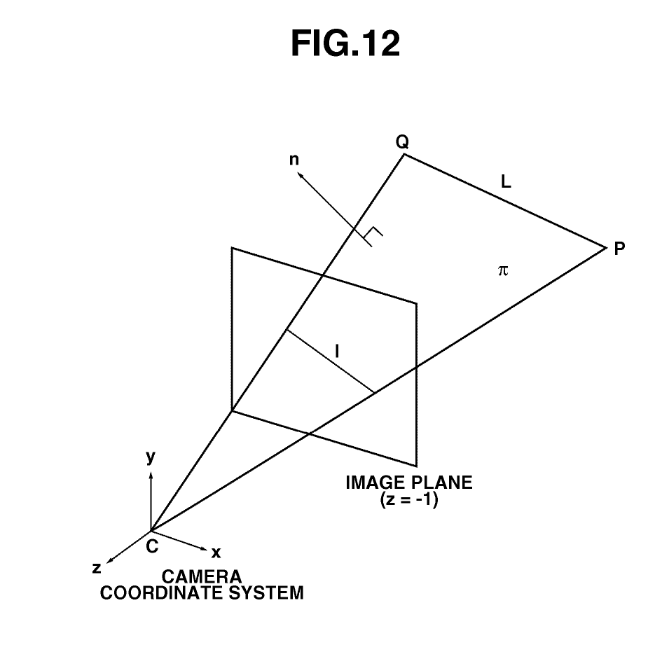

FIG. 12 illustrates a relationship between a straight line in an image and a straight line in a three-dimensional space. In general, when a three-dimensional straight line is captured by an imaging apparatus, a projection image of the three-dimensional straight line becomes a straight line when it is projected on an image plane.

As illustrated in FIG. 12, a straight line L passes through two points P and Q in the three-dimensional space. A straight line l is a projection image of the straight line L projected on the image plane. The straight line l is a crossing line of the image plane and a plane π. The plane π is a plane including the straight line L and a viewpoint C. Further, a normal vector n of the plane π is perpendicular to vectors CP, CQ, and PQ.

When three-dimensional vectors p and q represent the point P and the point Q in the standard coordinate system, a direction vector d (=q−p) represents the straight line L in the standard coordinate system. Further, three orthogonal conditions can be expressed using the following formulae (7) to (9).

n·(R_{cw}p+t_{cw})=0 (7)

n·(R_{cw}q+t_{cw})=0 (8)

n·R_{cw}d=0 (9)

Further, Rcw is a 3×3 rotation matrix that represents the orientation of the standard coordinate system relative to the camera coordinate system, and tcw is a three-dimensional vector that represents the position of the standard coordinate system relative to the camera coordinate system. In the present exemplary embodiment, Rcw can be expressed using the following formula (10).

$${R}_{cw} = ⌊ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ⌋ \qquad ( 10 )$$

When n=[nx ny nz]t, p=[px py pz]t, q=[qx qy qz]t, and tcw=[tx ty tz]t, inputting the rotation matrix Rcw expressed by the formula (10) into the formulae (7) and (8) can obtain the following formulae (11) and (12).

nₓ(r₁₁pₓ+r₁₂p_{y}+r₁₃p_{z})+nₓ(r₁₁pₓ+r₁₂p_{y}+r₁₃pz)+nₓ(r₁₁pₓ+r₁₂p_{y}+r13pz+nxtx+nyty+nztz=0 (11)

nₓ(r₁₁qₓ+r₁₂q_{y}+r₁₃q_{z})+nₓ(r₁₁qₓ+r₁₂q_{y}+r₁₃q_{z})+nₓ(r₁₁qₓ+r₁₂q_{y}+r13qz+nxtx+nyty+nztz=0 (12)

The above-described formulae (11) and (12) are linear equations including unknown variables r11, r12, r13, r21, r22, r23, r31, r32, r33, tx, ty, and tz. Further, when coordinates (x1, y1) and (x2, y2) represent two passing points of the straight line detected on the image in the coordinate system of the image plane having the above-described focal length (=1), the camera coordinates can be expressed using the following formulae.

X_{C1}=[x₁y₁−1]^{t}

X_{C2}=[x₂y₂−1]^{t}

The normal vector n is a vector perpendicular to both of xc1 and xc2. Therefore, the normal vector n can be expressed using a formula n=xc1×xc2. Thus, the straight line detected in an image can be correlated with a straight line constituting the three-dimensional space, as an equation, via the normal vector n.

The position and orientation estimation apparatus 2 calculates the position and orientation of an object by solving simultaneous equations (11) and (12), which are established with respect to the correspondence between straight lines in a plurality of images and straight lines in the three-dimensional space, for the variables r11, r12, r13, r21, r22, r23, r31, r32, r33, tx, ty, and tz.

The rotation matrix calculated in the above-described processing does not satisfy normal orthogonal basis conditions because inherently non-independent elements of the rotation matrix are independently obtained.

Hence, the position and orientation estimation apparatus 2 performs singular value decomposition on the rotation matrix and further performs orthonormalization to calculate a rotation matrix assured in orthogonality of the axis.

After the above-described imaging apparatus position and orientation calculation method in step S2040 is completed, the processing proceeds to step S2050.

In step S2050, the position and orientation estimation apparatus 2 calculates an evaluation value of the position and orientation calculated in step S2040. More specifically, the position and orientation estimation apparatus 2 projects the line segment of the three-dimensional model based on the position and orientation calculated in step S2040 and determines whether the projected pixel is an edge area.

The evaluation value used in the present exemplary embodiment is the number of pixels existing as edges positioned on the projected line segment of the three-dimensional model. When an edge in the image overlaps with a projected line segment of the three-dimensional model, the evaluation value becomes a larger value.

However, the evaluation value of the position and orientation is not limited to the above-described one. Any other method is employable as an index measuring the validation with respect to the position and orientation of the object. The determination of the evaluation value is not particularly restricted.

In step S2060, the position and orientation estimation apparatus 2 determines the validation of the position and orientation calculated in step S2040 with reference to the evaluation value calculated in step S2050.

If it is determined that the position and orientation is accurately calculated (NO in step S2060), the position and orientation estimation apparatus 2 terminates the processing of the flowchart illustrated in FIG. 9.

If it is determined that the position and orientation is not accurately calculated (YES in step S2060), the processing returns to step S2040 to calculate new combinations and perform again the above-described position and orientation calculation.

The position and orientation estimation apparatus 2 performs the validation determination by determining whether the evaluation value calculated in step S2050 is equal to or greater than a predetermined value. For example, an experimentally obtained threshold value is usable in the validation determination of the evaluation value.

Alternatively, the position and orientation estimation apparatus 2 can repeat the processing in steps S2040 and S2050 for all combinations of the line segment constituting the three-dimensional model and the straight line included in the image and then select a maximum evaluation value.

Alternatively, the position and orientation estimation apparatus 2 can select a predetermined number of combinations in step S2040 and select the one having a largest evaluation value.

Any other evaluation value determination method is employable as long as a combination for accurately calculating the position and orientation is selectable from various combinations of the line segment constituting the three-dimensional model and the straight line included in the image.

In the present exemplary embodiment, the position and orientation estimation apparatus 2 stores the evaluation value calculated in step S2050 together with obtained position and orientation data, repeats the processing in steps S2040, S2050, and S2060 one thousand times, and finally selects the position and orientation having a largest evaluation value.

As described above, the position and orientation estimation apparatus according to the present exemplary embodiment correlates a straight line extracted from an image with a line segment constituting a three-dimensional model based on a distance distribution extracted from a distance image. Further, the position and orientation estimation apparatus according to the present exemplary embodiment directly calculates the position and orientation of an imaging apparatus based on the correlated straight line and the line segment constituting the three-dimensional model.

In the above-described exemplary embodiment and the modified embodiments, features included in a two-dimensional image are edge features. However, the features included in a two-dimensional image are not limited to only the edge features and can be any other features.

For example, as discussed in I. Skrypnyk and D. G. Lowe, “Scene modelling, recognition and tracking with invariant image features,” Proc. The 3rd IEEE/ACM International Symposium on Mixed and Augmented Reality (ISMAR04), pp. 110-119, 2004″ (hereinafter, referred to as non-patent literature 7), it is useful to use an assembly of three-dimensional position coordinates of point features that represent a three-dimensional shape model of a target object, detect point features as image features, and calculate the position and orientation of the target object based on the correspondence between three-dimensional coordinates of respective feature points and two-dimensional coordinates on the image.

Point features represented by Harris or SIFT are detectable as image features. In many cases, their feature amounts are described on the premise that a point feature area is locally flat. Referring to a distance image and checking the local flatness of a point feature can remove any point feature that is not locally flat. Thus, it is feasible to reduce error correspondence of point features in the position and orientation estimation of a non-flat object.

Further, the point features are not limited to the above-described ones. The gist of the present exemplary embodiment can be realized even when point features to be used in the calculation of the position and orientation are other type of point features or a combination of a plurality of features (feature points and edges).

The three-dimensional coordinate measurement apparatus used in the above-described exemplary embodiments and modified embodiment is the distance sensor configured to output a dense distance image. However, the three-dimensional coordinate measurement apparatus is not limited to the above-described one and can be another measurement apparatus that performs coarse measurement. For example, a distance measurement apparatus using spot light is employable to determine a three-dimensional attribute of an image feature.

However, in this case, expression of a three-dimensional coordinate is simple three-dimensional point group information, which cannot be regarded as an image. Therefore, in step S1040, it is difficult to determine the three-dimensional attribute based on a second-order differential value of the three-dimensional coordinate data in the vicinity of the control point.

To solve the above-described problem, for example, it is useful to search for a three-dimensional point group existing around an image feature and determine the shape by performing line fitting or plane fitting on the three-dimensional point group.

Further, it is useful to perform singular value decomposition on the three-dimensional point group and determine a flatness of the three-dimensional point group based on a decomposition result. Further, it is useful to perform principal component analysis on the three-dimensional point group and determine the flatness based on a principal axis direction and dispersion. The shape estimation method is not limited to the above-described one and any other method can be used if features of a peripheral shape of an image feature can be estimated.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-040594 filed Feb. 25, 2010, which is hereby incorporated by reference herein in its entirety.

What is claimed is:

1. A position and orientation estimation apparatus, comprising:
a storage unit configured to store a three-dimensional model representing a shape of an object;
an extraction unit configured to extract an image feature from an image including the captured object;
an input unit configured to input a distance image that includes measured information relating to the object;
a correlating unit configured to correlate the image feature corresponding to the distance image that coincides with the three-dimensional model in shape, with the three-dimensional model; and
an estimation unit configured to estimate the position and orientation of the object based on a correlating result obtained by the correlating unit.

2. The position and orientation estimation apparatus according to claim 1, further comprising:
an approximate position and orientation input unit configured to input an approximate position and orientation of the object,
wherein the estimation unit is configured to estimate the position and orientation of the object by correcting the approximate position and orientation.

3. The position and orientation estimation apparatus according to claim 1, wherein the image feature is an edge feature or a point feature.

4. A position and orientation estimation method, comprising:
storing a three-dimensional model representing a shape of an object;
extracting an image feature from an image including the captured object;
inputting a distance image that includes measured information relating to the object;
correlating the image feature corresponding to a portion of the distance image that coincides with the three-dimensional model in shape, with the three-dimensional model; and
estimating the position and orientation of the object based on an obtained correlating result.

5. A non-transitory computer-readable storage medium storing a program that causes a computer to perform position and orientation estimation processing, the program comprising:
computer-executable instructions for storing a three-dimensional model representing a shape of an object;
computer-executable instructions for extracting an image feature from an image including the captured object;
computer-executable instructions for inputting a distance image that includes measured information relating to the object;
computer-executable instructions for correlating the image feature corresponding to a portion of the distance image that coincides with the three-dimensional model in shape, with the three-dimensional model; and
computer-executable instructions for estimating the position and orientation of the object based on an obtained correlation result.
